(19) United States
(12) Patent Application Publication
(10) Pub. No.: US 2021/0254384 A1
(43) Pub. Date: Aug. 19, 2021

(54) PROCESS FOR ADHERING DECORATIVE ACCESSORIES TO MAGNETICALLY RETAIN THEM ON A GARAGE DOOR

(71) Applicant: Robert A. Kelley, Buena Park, CA (US)

(72) Inventor: Robert A. Kelley, Buena Park, CA (US)

(21) Appl. No.: 16/791,358

(22) Filed: Feb. 14, 2020

(51) Int. Cl. E05D 15/24; E05B 1/00; G10K 3/00

(52) U.S. Cl. CPC E05D 15/242; E05B 1/00; H01F 7/02; E05Y 2900/106; G10K 3/00

(57) ABSTRACT

Steel garage door decorations made out of powder coated aluminum. The decorations include a decorative hinge, a decorative barn door handle, a decorative knocker assembly and a decorative clavo. Each of the garage door decorations is made out of powder coated aluminum and retains at least one concealed permanent magnet by which the decoration is temporarily affixed to a garage door panel. Each decoration also contains at least one recess where adhesive can be applied after the proper orientation and location of each respective garage door decoration have been finalized.

### BACKGROUND OF THE INVENTION

### 1. Field of the Invention

The present invention relates to the field of garage doors and in particular, to decorative fixtures attached to the front panels incorporated into a garage door to enhance the aesthetic beauty of the garage door.

### 2. Description of the Prior Art

The present inventor is an innovator in the field of garage doors, including improving the functionality and the aesthetic beauty of garage doors.

The present inventor is the inventor of nineteen issued United States utility and design patents in the field of garage doors. However, the present inventor is not aware of any issued patents or any printed publications which identically disclose or make the innovation set forth herein obvious.

### SUMMARY OF THE INVENTION

The front panel of garage doors is most frequently made of metal. Most front panels of garage doors are made of steel. It is a fundamental discovery of the present invention that objects which include a permanent magnet are removably and adjustably retained against any desired location on the front of a steel garage door.

The present invention is an accessory which is magnetically retained onto a garage door and is shaped in the form of heavy and expensive garage door decorations frequently made out of heavy cast iron which is permanently affixed to the front of a garage door and have the following shapes: (1) an elongated hinge; (2) simulated barn door handles; (3) door knockers; and (4) clavos.

Once a cast iron garage door decoration is affixed, it is difficult to remove. If the prior art cast iron garage door decoration is removed after being affixed, it will leave an ugly scar at the locations where the cast iron decoration was affixed.

It has been discovered that an aluminum garage door decoration is significantly lighter than a cast iron decoration. Aluminum will react with the steel material out of which the garage door panel is made; however, if the aluminum is powder coated, it will eliminate the adverse reaction between aluminum and steel.

It has further been discovered that if the powder coated aluminum decoration contains at least one permanent magnet, the decoration can be temporarily affixed to the garage door panel. In this way, a worker can arrange the garage door panels for the owner's approval. If the owner disapproves of the arrangement of the decorations, the decoration can be moved to any desired location by exerting a force to release the magnetic attraction of the permanent magnet to the steel garage door panel and then relocate the decoration to the owner's satisfaction. The relocated decoration is temporarily affixed by the permanent magnet.

Once finally approved, a bonding adhesive is applied between the steel garage door panel and the interior of the decoration to permanently affix the decoration. In this way, the decoration is permanently affixed and will not be stolen or accidentally moved.

It is therefore an object of the present invention to powder coat an aluminum garage door decoration to eliminate an adverse reaction between the aluminum garage door decoration and the steel panel of the garage door.

It is a further object of the present invention to provide at least one concealed permanent magnet in the aluminum powder coated garage door decoration to temporarily affix the aluminum powder coated garage door decoration to the garage door panel to be certain of an owner's desired positioning of the garage door decoration before it is permanently affixed.

It is an additional object of the present invention to incorporate the innovations of the present invention into the following garage door decorations: (1) an elongated hinge; (2) simulated barn door handles; (3) door knockers; and (4) clavos.

Further novel features and other objects of the present invention will become apparent from the following detailed description, discussion and the appended claims, taken in conjunction with the drawings.

### BRIEF DESCRIPTION OF THE DRAWINGS

Referring particularly to the drawings for the purpose of illustration only and not limitation, there is illustrated:

FIG. 1 is a front and side perspective view of the present invention garage door hinge;

FIG. 2 is a rear and side perspective view of the present invention garage door hinge;

FIG. 3 is a rear plan view of the present invention garage door hinge;

FIG. 4 is a front and side perspective view of the present invention barn door handle decoration;

FIG. 5 is a rear and side perspective view of the present invention barn door handle decoration;

FIG. 6 is a rear plan view of the present invention barn door handle decoration;

FIG. 7 is a front and side perspective view of the present invention knocker garage door decoration, with the strike plate in its conventional locative relative to the striking ring;

FIG. 8 is a rear and side perspective view of the present invention knocker garage door decoration, with the strike plate illustrated below the striking ring to illustrate the interior components of the strike plate;

FIG. 9 is a rear plan view of the present invention knocker garage door decoration, with the strike plate illustrated below the striking ring to illustrate the interior components of the strike plate;

FIG. 10 is a front and side perspective view of the present invention clavo garage door decoration;

FIG. 11 is a rear and side perspective view of the present invention clavo garage door decoration; and

FIG. 12 is a front and perspective view of a garage door with the following embodiments of the present invention garage door decorations affixed to one or more garage door panels: (1) a pair of elongated hinges; (2) a pair pf simulated barn door handles; (3) a door knocker assembly; and (4) a clavo.

### DETAILED DESCRIPTION OF EMBODIMENTS OF THE PRESENT INVENTION

Although specific embodiments of the present invention will now be described with reference to the drawings, it should be understood that such embodiments are by way of example only and merely illustrative of but a small number of the many possible specific embodiments which can represent applications of the principles of the present invention. Various changes and modifications obvious to one skilled in the art to which the present invention pertains are deemed to be within the spirit, scope and contemplation of the present invention as further defined in the appended claims.

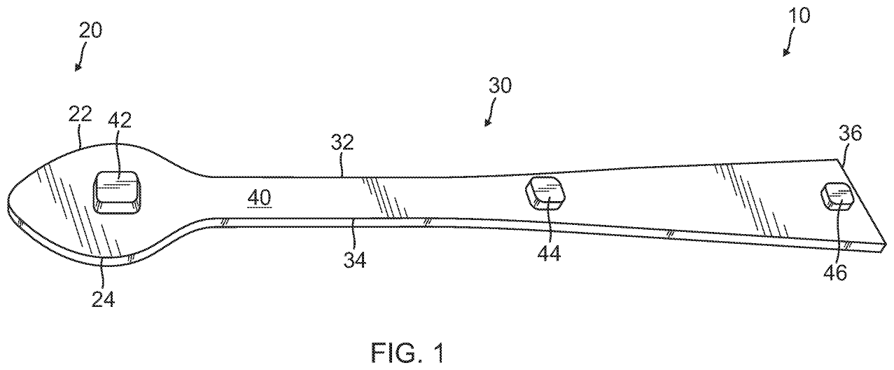

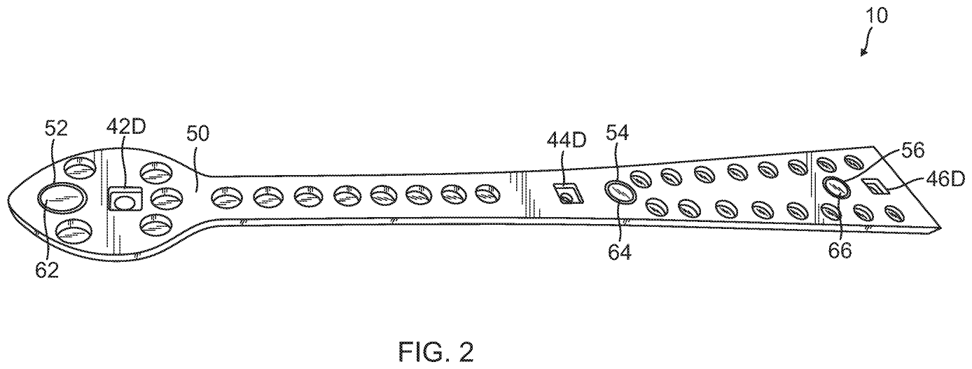

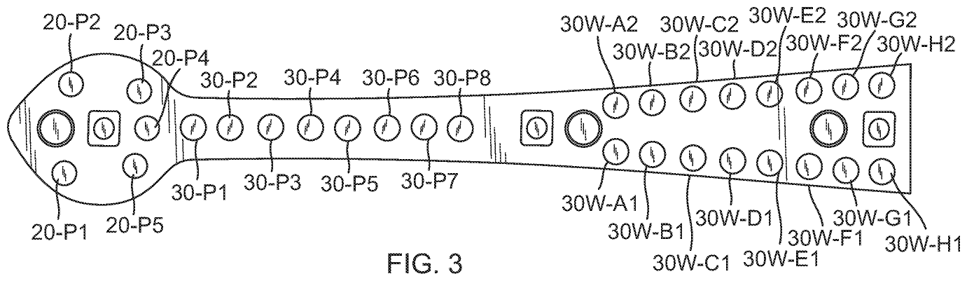

Referring to FIG. 1, there is illustrated a front and side perspective view of the present invention garage door hinge. Referring to FIG. 2, there is illustrated a rear and side perspective view of the present invention garage door hinge. Referring to FIG. 3, there is illustrated a rear plan view of the present invention garage door hinge.

Referring to FIGS. 1, 2 and 3, the present invention garage door hinge decoration 10 has a rounded first end 20 with a first arcuate sidewall 22 and an oppositely disposed mirror image second arcuate sidewall 24 extending to an elongated shaft 30 with a narrow end integral with the arcuate sidewalls 22 and 24 of rounded first end 20 and extended to parallel elongated first shaft sidewall 32, and a mirror image elongated second shaft sidewall 34 terminating in a transverse shaft rear end 36.

The front surface 40 has three spaced apart protrusions 42, 44 and 46 extending perpendicularly in front of front surface 40. Referring to FIGS. 2 and 3, the rear surface 50 includes three spaced apart cylindrical depressions which include first cylindrical depression 52 within rounded first end 20, a second cylindrical depression 54 within elongated shaft section 30, and a third cylindrical depression 56 adjacent transverse shaft rear end 36. A first cylindrical permanent magnet 62 is retained with first cylindrical depression 52. A second cylindrical permanent magnet 64 is retained within second cylindrical depression 54. A third cylindricaln permanent magnet 66 is retained within third cylindrical depression 56. Each permanent magnet 62, 64 and 66 is located on rear surface 50 and therefore they are concealed from view.

Further referring to FIGS. 2 and 3, corresponding square depressions 42D, 44D and 46D are respectively aligned with respective protrusion 42, 44 and 46. The rear surface 50 further comprises a multiplicity of indented pockets within rounded front end 20 and elongated shaft 30. The five pockets within rounded front 20 are numbered 20-P1, 20-P2. 20-P3, 20-P4 and 20-P5. The eight pockets along the slender portion of shaft 30 are numbered 30-P1, 30-P2, 30-P3, 30-P4, 30-P5, 30-P6, 30-P7 and 30-P8. Spaced apart pairs of pockets are parallel to each other along the widened portion of shaft 30 and are numbered 30W-A1 and 30W-A2; 30W-B1 and 30W-B2; 30W-C1 and 30W-C2; 30W-D1 and 30W-D2; 30W-E1 and 30W-E2; 30W-F1 and 30W-F2; 30W-G1 and 30W-G2; 30W-H1 and 30W-H2.

The hinges are usually affixed in spaced apart pairs with the widened end 36 closest to each other and the rounded ends 20 further away from each other.

Each hinge 10 is made of aluminum and is entirely powder coated to avoid a negative reaction between the aluminum and the steel garage door panel. A worker places a rear surface 50 against a garage door panel and the hinge is magnetically retained against the steel garage door panel by the three permanent magnets 62, 64 and 66. If the homeowner is not happy with the positioning or location of the hinge on the garage door, a forward force on the hinge releases the magnetic attraction and the hinge is relocated to a desired location and orientation. Once a final determination on location and orientation is made, bonding adhesive is placed into a selected group of pockets selected from one or more of the following pockets: pockets from the rounded front 20-20-P1, 20-P2. 20-P3, 20-P4 and 20-P5, and the eight pockets along the slender portion of shaft 30 are numbered 30-P1, 30-P2, 30-P3, 30-P4, 30-P5, 30-P6, 30-P7 and 30-P8, and the spaced apart pairs of pockets 30W-A1 and 30W-A2; 30W-B1 and 30W-B2; 30W-C1 and 30W-C2; 30W-D1 and 30W-D2; 30W-E1 and 30W-E2; 30W-F1 and 30W-F2; 30W-G1 and 30W-G2; 30W-H1 and 30W-H2. In this away, the hinge 10 is permanently affixed so it will not be moved from its desired location and will not be stolen.

While described as a first cylindrical depression, a second cylindrical depression and a third cylindrical depression, it is within the spirit and scope of the present invention for the first, second and third depression to be any shape in addition to cylindrical. Also while described as first cylindrical permanent magnet, second cylindrical permanent magnet and third cylindrical permanent magnet, it is within the spirit and scope of the present invention for the permanent magnet to be in any shape.

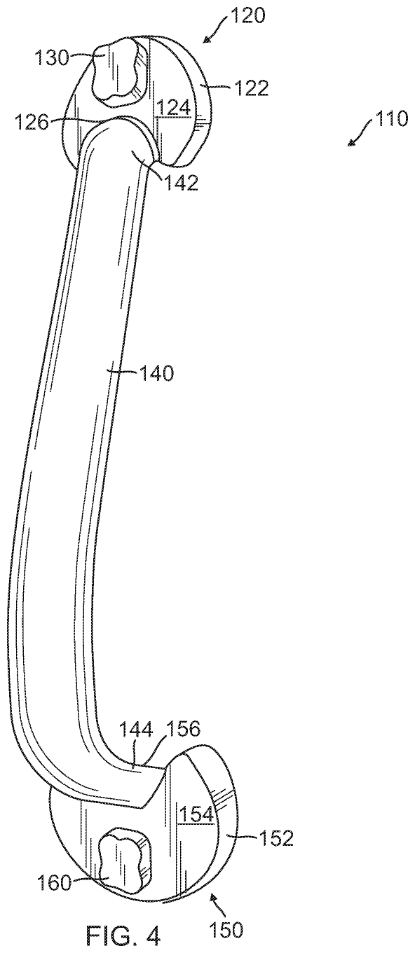

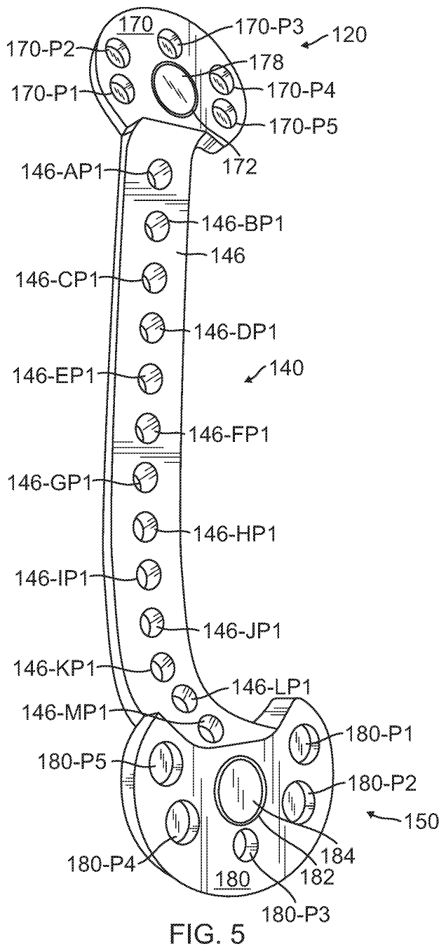

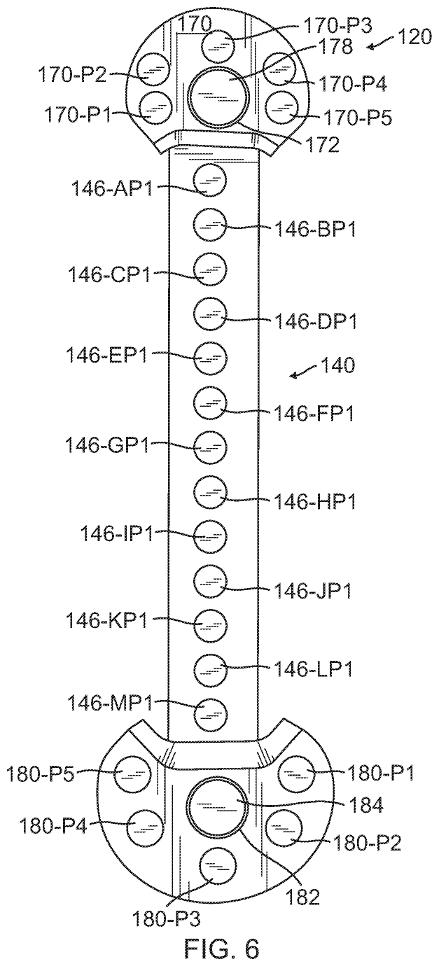

Referring to FIG. 4, there is illustrated a front and side perspective view of the present invention barn door handle decoration. Referring to FIG. 5, there is illustrated a rear and side perspective view of the present invention barn door handle decoration. Referring to FIG. 6, there is illustrated a rear plan view of the present invention barn door handle decoration.

Referring to FIGS. 4, 5 and 6, the barn door handle 110 includes an upper arcuate section 120 with a rounded sidewall 122 and a protrusion 130 extending perpendicularly from the front surface 124. The most interior portion 126 of the rounded sidewall extends to a handle section 140 with an upper end 142 integral with the most interior sidewall 126. The handle section 140 has a lower end 144 which is integral with a lower arcuate section 150 with a rounded sidewall 152 and a protrusion 160 extending perpendicularly from the front surface 154. The innermost portion 156 of the lower rounded sidewall 152 is integral with the lower end 144 of the handle section 140.

Referring to FIGS. 5 and 6, the upper arcuate section 120 has an interior surface 170 with a cylindrical depression 172 which retains a first rounded cylindrical magnet 178 set below interior surface 170. Interior surface 170 includes five interior pockets 170-P1, 170-P2. 170-P3, 170-P4 and 170-P5. The handle section 140 has an interior surface 146 with thirteen pockets along the interior surface 146 of handle section 140 which are numbered 146-AP1, 146-BP1, 146-CP1, 146-DP1, 146-EP1, 146-FP1, 146-GP1, 146HP1, 146-IP1, 146-JP1, 146-KP1, 146-LP1 and 146-MP 1.

The lower arcuate section 150 has an interior surface 180 with a cylindrical depression 182 which retains a second rounded cylindrical magnet 184 set below interior surface 180. Interior surface 180 includes five interior pockets 180-P1, 180-P2. 180-P3, 180-P4 and 180-P5.

The barn door handles are usually affixed in spaced apart pairs with the upper arcuate section 120 above the lower arcuate section 150 with the handle section 140 vertically aligned between them.

Each barn door handle 110 is made of aluminum and is entirely powder coated to avoid a negative reaction between the aluminum and the steel garage door panel. A worker then places an interior surface 170 of upper arcuate section 120 against a garage door panel and the upper arcuate section 120 is magnetically retained against the steel garage door panel by the first cylindrical permanent magnet 178. The worker places the interior surface 180 of the lower arcuate section 150 with the permanent second rounded cylindrical magnet 184 retained against the steel garage door panel.

If the homeowner is not happy with the positioning or location of the barn door handle 110 on the garage door, a forward force on the barn door handle 110 releases the magnetic attraction and the barn door handle is relocated to a desired location and orientation. Once a final determination on location and orientation is made, bonding adhesive is placed into a selected group of pockets selected front one or more of the following pockets: 170-P1, 170-P2. 170-P3, 170-P4 and 170-P5 from the upper arcuate section 120 and interior pockets 180-P1, 180-P2. 180-P3, 180-P4 and 180-P5 from the lower rounded arcuate section 150. The barn door handle 110 is then permanently affixed and will not move and will not be stolen.

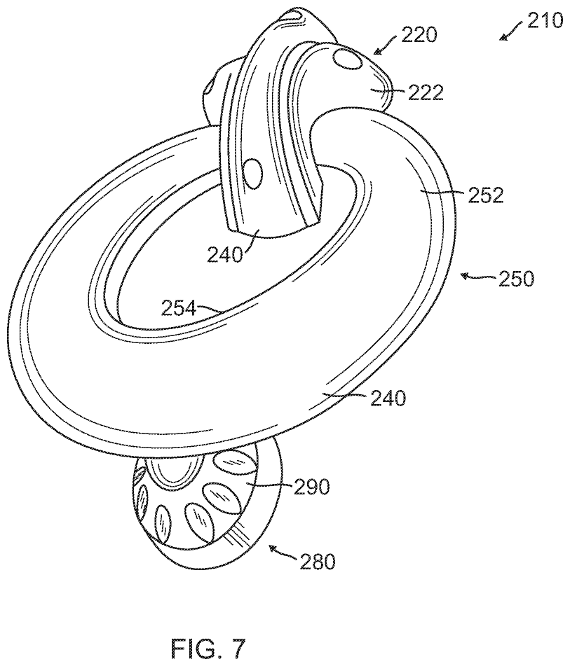

Referring to FIG. 7, there is illustrated a front and side perspective view of the present invention knocker garage door decoration, with the strike plate in its conventional locative relative to the striking ring.

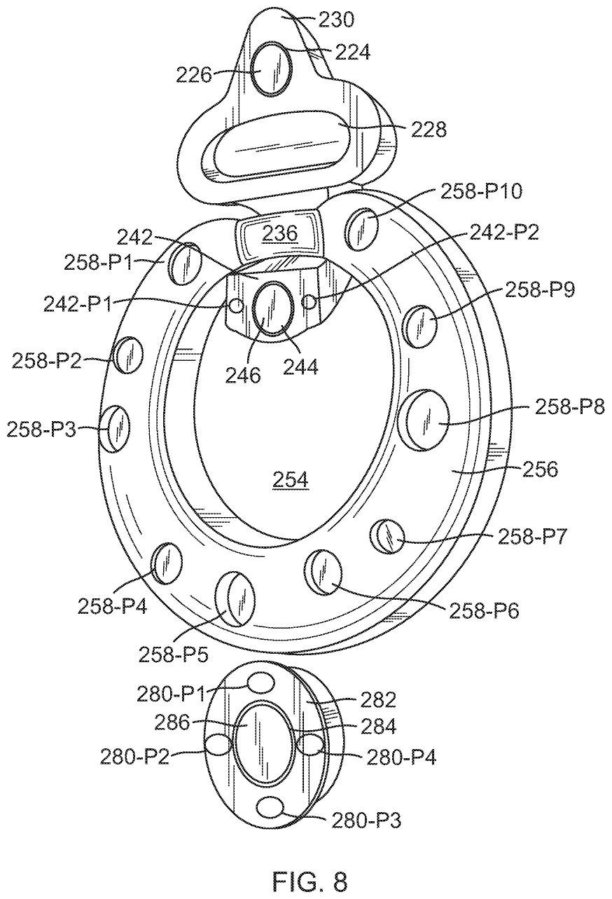

Referring to FIG. 8, there is illustrated a rear and side perspective view of the present invention knocker garage door decoration, with the strike plate illustrated below the striking ring to illustrate the interior components of the strike plate.

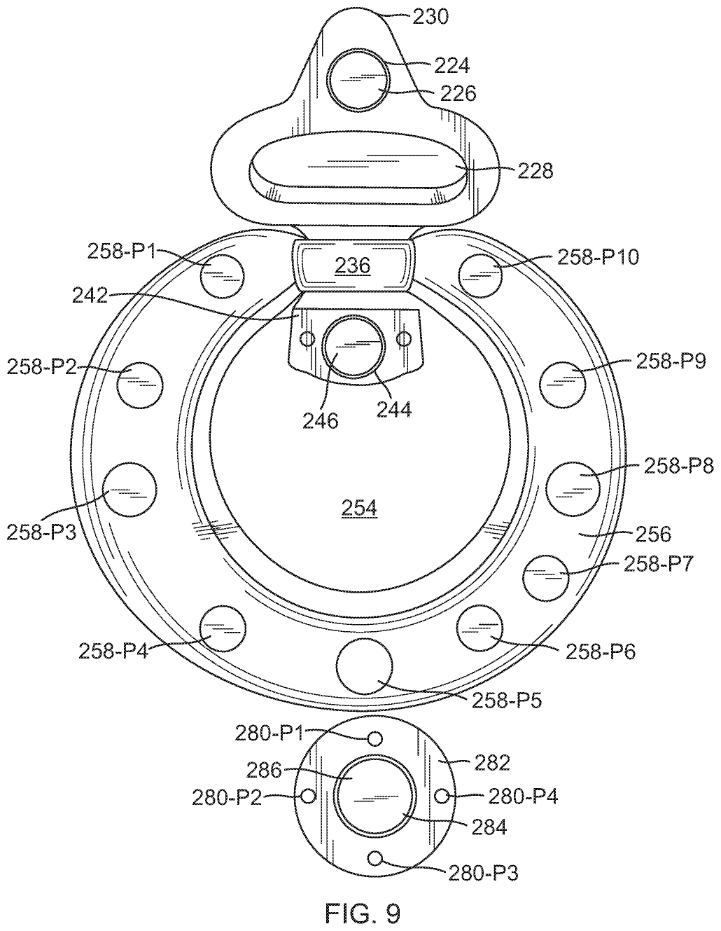

Referring to FIG. 9, there is illustrated a rear plan view of the present invention knocker garage door decoration with the strike plate illustrated below the striking ring to illustrate the interior components of the strike plate.

Referring to FIGS. 7, 8 and 9, the conventional door knocker 210 has three primary component parts which are a striking ring retainer 220; a striking ring 250 and a strike plate 280. All three parts are illustrated in FIG. 7.

Referring to FIGS. 7, 8 and 9, the ring retainer 220 has an upper section 222 with an upper rear surface 230 having a cylindrical depression 224 retaining a first cylindrical permanent magnet 226 set slightly below upper rear surface 230. The ring retainer 220 has an oval pocket 228 within upper rear surface 230. The ring retainer 220 has a lower section 240 having a rear surface 242 with a cylindrical depression 244 retaining a second cylindrical permanent magnet 246 set slightly below rear surface 242. The rear surface 242 includes pockets 242-P1 and 242-P2. A ring channel 236 is set between upper section 222 and lower section 240. The upper section 222 and lower section 240 are respectively retained against a garage door panel by first cylindrical permanent magnet 226 and second cylindrical permanent magnet 246.

A striking ring 250 has a body 252 which surrounds an interior opening 254. The striking ring 250 has a flat rear surface 256 with a multiplicity of weight reduction pockets 258-P1, 258-P2, 258-P3, 258-P4, 258-P5. 258-P6, 258-P7, 258-P8, 258-P9 and 258-P10.

The third component is a strike plate 280 having a front surface 290 and a rear surface 282 with cylindrical depression 284 retaining a third cylindrical permanent magnet 286 set slightly below rear surface 282. The rear surface 282 of the strike plate 280 includes recessed pockets 280-P1, 280-P2, 280-P3 and 280-P4. The strike plate 280 is retained against a garage door panel by a third cylindrical permanent magnet and spaced apart from the striking ring retainer 220 so that the striking ring 250 will ring the strike plate 280 to make a knocking noise.

The a striking ring retainer 220 is made of aluminum and is entirely powder coated to avoid a negative reaction between the aluminum and the steel garage door panel. The striking ring 250 is made of aluminum and is entirely powder coated to avoid a negative reaction between the aluminum and the steel garage door panel. The strike plate 280 is made of aluminum and is entirely powder coated to avoid a negative reaction between the aluminum and the steel garage door panel.

A worker places the upper rear surface 230 of the upper section 222 and the rear surface of the lower section 240 onto the steel garage door panel where the sections are respectively retained by the first cylindrical permanent magnet 226 and the second cylindrical permanent magnet 246 while the striking ring 250 is retained as previously described. The worker then places the rear surface 282 of the striking plate 2980 against the steel garage door panel at a distance where the front 290 of the strike plate 280 is hit by the striking ring 250 and the strike plate 280 is retained by the third cylindrical permanent magnet 286.

If the homeowner is not happy with the positioning or location of the strike plate assembly 210 on the garage door, a forward force on each component releases the magnetic attraction and the components of the strike plate assembly 210 are relocated to a desired location and orientation. Once the final determination on location and orientation is made, bonding adhesive is placed between the steel garage door panel and into a selected group of pockets such as oval pocket 228, pockets 242-P1 and 242-P2, and pockets 280-P1, 280-P2, 280-P3 and 280-P4 to permanently affix the knocker assembly 210 to the garage door panel. In this way, the knocker assembly 210 will not be stolen or accidentally moved.

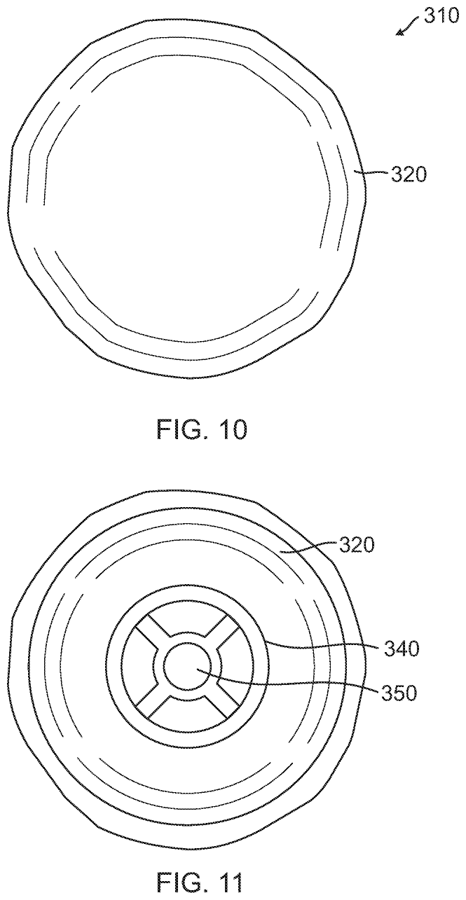

Referring to FIG. 10, there is illustrated a front and side perspective view of the present invention clavo garage door decoration. Referring to FIG. 11, there is illustrated a rear and side perspective view of the present invention clavo garage door decoration.

Referring to FIG. 10, there is illustrated a front and side perspective view of the present invention clavo garage door decoration.

Referring to FIG. 11, there is illustrated a rear and side perspective view of the present invention clavo garage door decoration.

Referring to FIGS. 10 and 11, the clavo 310 has a partially semi-hemispherical front surface 320 and a concave rear surface 330 with a concave rear cavity 340 retaining a clavo cylindrical permanent magnet 350 surrounded by the remainder of the concave rear cavity 340.

A worker places the rear surface 330 against a steel garage door panel where it is retained by the clavo cylindrical permanent magnet. If the homeowner is not happy with the location of the clavo on the garage door, a forward force on the clavo releases the magnetic attraction and when the clavo is moved to a location approved by the owner, adhesive is placed into the concave rear cavity and the clavo is bonded to the garage door panel. In this way, the clavo will not move or be stolen.

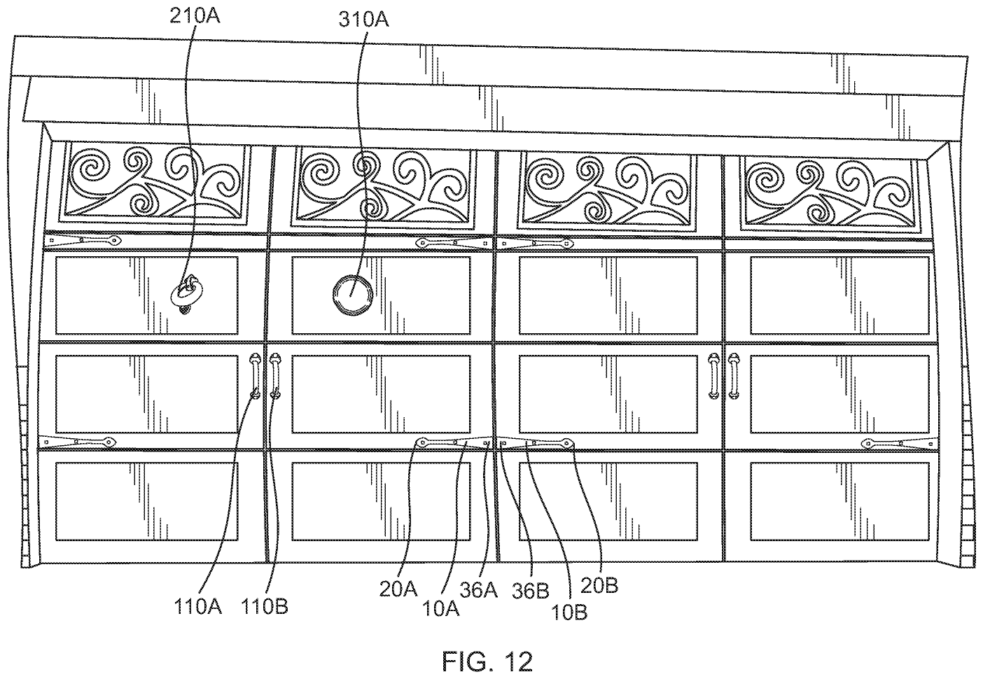

Referring to FIG. 12, there is illustrated a front and perspective view of a garage door with the following embodiments of the present invention garage door decorations affixed to one or more garage door panels in the manner previously described for each respective decoration.

A pair of elongated hinges 10A and 10B are at spaced apart locations and each contain the same components as described in detail with references to FIGS. 1, 2 and 3. The two hinges 10A and 10B are horizontally aligned in the same vertical row with each respective widened end 36A and 36B closest to each other and the respective rounded ends 20A and 20B furthest away from each other. It will be appreciated that it is within the spirit and scope of the present invention to have only one elongated hinge affixed to a garage door panel or to have any multiplicity of individual elongated hinges or any multiplicity of pairs of elongated hinges affixed to the garage door panel. While a horizontal orientation is preferred, any orientation is within the spirit and scope of the present invention.

Further referring to FIG. 12, a pair of barn door handles 110A and 110B contain the same components as described with references to FIGS. 4, 5 and 6 and are affixed to the garage door panel as previously described. It will be appreciated that it is within the spirit and scope of the present invention to have any multiplicity of barn door handles 110 affixed to the garage door panels at any location or locations.

Further referring to FIG. 12, there is illustrated a knocker assembly 210A having the same components as described with reference to FIGS. 7, 8 and 9 and affixed in the same way as previously described. It will be appreciated that it is within the spirit and scope of the present invention to have any multiplicity of knocker assemblies 210 affixed to the garage door panels at any location

Further referring to FIG. 12, there is a clavo 310A having the same components as described with reference to FIGS. 10 and 11 and affixed in the same way as previously described. It will be appreciated that it is within the spirit and scope of the present invention to have any multiplicity of clavos 310 affixed to the garage door panels at any location

Of course the present invention is not intended to be restricted to any particular form or arrangement, or any specific embodiment, or any specific use, disclosed herein, since the same may be modified in various particulars or relations without departing from the spirit or scope of the claimed invention hereinabove shown and described of which the apparatus or method shown is intended only for illustration and disclosure of an operative embodiment and not to show all of the various forms or modifications in which this invention might be

What is claimed is:

1. An elongated hinge adapted to be affixed to a garage door panel made of steel, the elongated hinge comprising:
(a) a rounded first end with a first arcuate sidewall and an oppositely disposed mirror image second arcuate sidewall, the first and second arcuate sidewalls extending to an elongated shaft with a narrow end integral with the first and second arcuate sidewalls and extending to a parallel elongated first shaft sidewall and a minor image elongated second shaft sidewall, both the elongated first shaft sidewall and second shaft sidewall terminating in a transverse shaft rear end;
(b) a rear surface including three spaced apart depressions, which include a first depression within a rounded first end, a second depression within said elongated shaft section, and a third depression adjacent the transverse shaft rear end, a first permanent magnet retained within said first depression, a second permanent magnet retained within said second depression, and a third permanent magnet retained within said third depression;
(c) said rear surface of said rounded front end having a multiplicity of indented pockets, and said interior surface of said elongated shaft section having a multiplicity of indented pockets;
(d) said rounded front end and said elongated shaft are made of powder coated aluminum; and
(e) said elongated hinge is retained against at least one steel panel of said garage door panel by magnetic attraction of said first, second and third permanent magnets to said steel garage door panel and permanently affixed to said steel garage door panel by bonding adhesive placed in several of said multiplicity of pockets.

2. The elongated hinge in accordance with claim 1, further comprising:
(a) said first depression is a cylindrical depression, said second depression is a cylindrical depression and said third depression is a cylindrical depression; and
(b) said first permanent magnet is a first cylindrical permanent magnet, said second permanent magnet is a second cylindrical permanent magnet, and said third magnet is a third cylindrical permanent magnet;

3. The elongated hinge in accordance with claim 1, the elongated hinge further comprising: a front surface with three spaced apart projections extending perpendicularly in front of the front surface.

4. The elongated hinge in accordance with claim 1, further comprising: the elongated hinge is made of powder coated aluminum.

5. The elongated hinge in accordance with claim 1, further comprising: two identical elongated permanent hinges aligned on said garage door panel, the elongated hinges spaced apart with the respective transverse ends closer to each other and the respective rounded ends further away from each other.

6. A barn door handle adapted to be affixed to a garage door panel made of steel, the barn door handle comprising:
(a) an upper arcuate section with a rounded sidewall and an upper front surface with an upper protrusion extending perpendicularly from the upper front surface, an interior portion of the rounded sidewall extending to a handle section with an upper end of the handle section integral with the interior portion of the rounded sidewall;
(b) a lower arcuate section with a rounded sidewall and a lower front surface with a lower protrusion extending perpendicularly from the lower front surface, an interior portion of the rounded sidewall extending to a handle section with a lower end of the handle section integral with the interior portion of the rounded sidewall;
(c) the upper arcuate section includes an upper interior surface with an upper depression which retains a first permanent magnet, the upper interior surface includes a multiplicity of interior pockets; and
(d) the lower arcuate section includes a lower interior surface with a lower depression which retains a second permanent magnet, the lower interior surface includes a multiplicity of interior pockets.

7. The door handle in accordance with claim 6, further comprising:
(a) the upper depression is a cylindrical depression and the first permanent magnet is a rounded cylindrical magnet; and
(b) the lower depression is a cylindrical depression and the second permanent magnet is a rounded cylindrical magnet.

8. The barn door handle in accordance with claim 6, further comprising: the handle has an interior surface.

9. The barn door handle in accordance with claim 8, further comprising: the interior surface of the handle has a multiplicity of pockets.

10. The barn door handle in accordance with claim 6, further comprising: the barn door handle is made of powder coated aluminum.

11. The barn door handle in accordance with claim 6, further comprising:
(a) a first barn door handle affixed to the steel garage door with the upper arcuate section above the lower arcuate section with the handle section vertically aligned between the upper arcuate section and the lower arcuate section and retained to the garage door by the first and second permanent magnets; and
(b) a spaced apart second identical barn door handle is affixed into the steel garage door with the upper arcuate section above the lower arcuate section with the handle section vertically aligned between the upper arcuate section and the lower arcuate section and retained to the garage door by the first and second permanent magnets.

12. A knocker decoration adapted to be affixed to a steel garage door, the knocker decoration comprising:
(a) the striking ring retainer; a striking ring; and a strike plate;
(b) the striking ring retainer:
(i) has an upper section with an upper rear surface having a cylindrical depression retaining a first cylindrical permanent magnet set slightly below the upper rear surface,
(ii) has an oval pocket within the upper rear surface,
(iii) has a lower section having a rear surface with a cylindrical depression retaining a second cylindrical permanent magnet set slightly below the rear surface,
(iv) a ring channel is set between the upper section and the lower section, the upper section and the lower section are respectively retained against a steel garage door panel by the first cylindrical permanent magnet and the second cylindrical permanent magnet;
(c) a striking ring has a body which surrounds an interior opening, the striking ring has a flat rear surface with at least one weight reduction pocket,
the striking ring is movably retained in the ring channel of the ring retainer;
(d) the strike plate:
(i) has a front surface and a rear surface, with a cylindrical depression retaining a third cylindrical permanent magnet set slightly below the rear surface,
(ii) the rear surface includes at least one recessed pocket,
(iii) the strike plate is retained against a steel garage door panel by the third cylindrical permanent magnet and spaced apart from the striking ring retainer so that the striking ring will ring the strike plate to make a knocking noise.

13. The knocker decoration in accordance with claim 12, further comprising:
(a) the a striking ring retainer is made of powder coated aluminum;
(b) the striking ring is made of powder coated aluminum; and
(c) the strike plate is made of power coated aluminum.

14. A clavo comprising:
(a) a partially semi-hemispherical front surface; and
(b) a concave rear surface with a concave rear cavity retaining a cylindrical permanent magnet.

15. The clavo in accordance with claim 14, further comprising: the clavo is made out of powder coated aluminum.
